(19) United States
(12) Patent Application Publication
(10) Pub. No.: US 2007/0202904 A1
(43) Pub. Date: Aug. 30, 2007

(54) Scheduling Method And Base Station Apparatus

(75) Inventors: Jun Cheng, Kyoto (JP); Akihiko Nishio, Kanagawa (JP)

Correspondence Address: STEVENS, DAVIS, MILLER & MOSHER, LLP, 1615 L. STREET N.W., SUITE 850, WASHINGTON, DC, 20036, US

(73) Assignee: Matsushita Electric Industrial Co., Ltd., Osaka (JP)

(21) Appl. No.: 10/591,951

(22) PCT Filed: Mar. 8, 2005
(86) PCT No.: PCT/JP05/04001

§ 371 Date: Sep. 8, 2006

(30) Foreign Application Priority Data
Mar. 12, 2004 (JP) 2004-070254

(51) Int. Cl. H04Q 7/20; H04B 7/00

(52) U.S. Cl. 455/509; 455/450

(57) ABSTRACT

A scheduling method and base station apparatus capable of maintaining an upstream line transfer rate in a local cell, while suppressing an adverse affection, which would otherwise be caused by interference, on another cell, that is, the reduction of an upstream line transfer rate in the other cell. In the apparatus, an upstream scheduler (120) calculates, based on a measurement result of reception SIR for each of the subcarriers of the upstream signals of the respective wireless communication terminal apparatuses (200), an average reception SIR of each upstream signal thereof, and then sequentially selects ones of the wireless communication terminal apparatuses (200) having lower calculated average reception SIRs. In addition, the upstream scheduler (120) assigns, to the selected ones of the wireless communication terminal apparatuses (200), upstream signal subcarriers that have not been assigned, in such a manner that sequentially assigns ones of the upstream signal subcarriers having higher reception SIRs and indicated by the measurement results of the selected wireless communication terminal apparatuses (200) received from a reception quality measuring part (112).

### TECHNICAL FIELD

In a radio communication system configured to include a base station apparatus and a plurality of radio communication terminal apparatuses, the present invention relates to a scheduling method and a base station apparatus, where the base station apparatus assigns subcarriers forming an uplink multicarrier signal to a plurality of radio communication terminal apparatuses.

### BACKGROUND ART

Conventionally, the HSDPA (High-Speed Downlink Packet Access) scheme of 3GPP (3rd Generation Partnership Project) employs adaptive modulation whereby a base station apparatus adaptively controls a modulation scheme a radio communication terminal apparatus uses in accordance with a propagation path state, and time scheduling whereby a base station apparatus selects a radio communication terminal apparatus having a relatively good propagation path state among a plurality of radio communication terminal apparatuses and assigns a transmission frame to the selected radio communication terminal apparatus (for example, see Non-Patent Document 1).

Also, in multicarrier transmission schemes including OFDM and MC-CDMA, which have been studied as transmission schemes for Beyond-3G mobile communication system, high-speed transmission is implemented using a large number of subcarriers. In such radio communication systems of a multicarrier transmission scheme, a base station apparatus performs frequency scheduling for frequencies used by radio communication terminal apparatuses using subcarrier-specific CQI (Channel Quality Indicator) transmitted from all radio communication terminal apparatuses (for example, see Patent Document 1 or Non-Patent Document 2).

As scheduling methods where a bases station apparatus assigns uplink channels or downlink channels to a plurality of radio communication terminal apparatuses according to propagation path states between the base station and those radio communication terminal apparatuses, three methods below are known:

1. Round Robin (RR) method: Transmission slots are randomly (evenly) assigned to a plurality of radio communication terminal apparatuses;

2. Maximum CIR (Max-C/I) method: A transmission slot is assigned to a radio communication terminal apparatus having the greatest instantaneous reception SIR (Signal to Interference Ratio); and

3. Proportional Fairness (PF) method: A transmission slot is assigned to a radio communication terminal apparatus having the greatest instantaneous reception SIR (SIR-inst/SIR-ave) with respect to an average reception SIR.

Although all these three scheduling methods are directed to a packet exchange scheme and invented for time scheduling, the scheduling methods are applicable to frequency scheduling in a multicarrier transmission scheme by replacing a packet with a subcarrier.

Patent Document 1: Japanese Patent Application Laid-Open No. 2002-252619

Non-Patent Document 1: Nortel Networks, “Nortel Network's references simulation methodology for the performance evaluation of OFDM/WCDMA in UTRAN,” 3GPP TSG-RAN-1 R1-03-0785

Non-Patent Document 2: Hara et al., “MC-CDM System for Packet Communications Using Frequency Scheduling”, Technical Report of IEICE, RCS2002-129, July 2002, pp. 61-pp. 66.

### DISCLOSURE OF INVENTION

### Problems to be Solved by the Invention

However, in a radio communication system of a multicarrier transmission scheme, when a base station performs frequency scheduling on subcarriers in a multicarrier signal for a plurality of radio communication terminal apparatuses by RR method, Max-C/I method, or PF method, there are the following problems.

FIG. 1 shows a radio communication system of a multicarrier transmission scheme having: base station apparatus 61 of cell A; base station apparatus 65 of cell B, which is adjacent to cell A; radio communication terminal apparatus 62 located on a cell edge of cell A; radio communication terminal apparatus 63 located relatively near base station apparatus 61; and radio communication terminal apparatus 66 located in cell B.

Also, the upper half of FIG. 2 is a graph showing an example of reception SIR of an uplink multicarrier signal per subcarrier transmitted from radio communication terminal apparatus 62 to base station apparatus 61 shown in FIG. 1 (dotted line), and reception SIR of an uplink multicarrier signal per subcarrier transmitted from radio communication terminal apparatus 63 to base station apparatus 61 (solid line). Also, the lower half of FIG. 2 shows results of performing frequency scheduling for subcarriers in the uplink signal using RR method, Max-C/I method, or PF method by base station apparatus 61 based on the reception SIR in the upper half of the figure. Here, the height of the blocks shown in the column of Max-C/I method and RR method in the lower half of FIG. 2 represents the modulation schemes and relative transmission rate corresponding to the modulation schemes. That is, the height of the blocks shown in the column of the methods in the lower half of FIG. 2 represents that, assuming transmission rate of the BPSK (Bi-Phase Shift Keying) modulation scheme is one bit as a standard, transmission rate of QPSK (Quadrature Phase Shift Keying) is two bits, and transmission rate of 16QAM (16 Quadrature Amplitude Modulation) is four bits. Further, in the upper half of FIG. 2, the thresholds of reception SIR at which BPSK, QPSK, and 16QAM become applicable are shown.

As shown in FIG. 1, the propagation distance between radio communication terminal apparatus 62 and base station 61 is longer than the propagation distance between radio communication terminal apparatus 63 and base station apparatus 61. Therefore, reception quality of an uplink multicarrier signal from radio communication terminal apparatus 62 is more likely to degrade due to adverse influences including propagation loss, than an uplink multicarrier signal from radio communication terminal apparatus 63. Hence, when radio communication terminal apparatus 62 and radio communication terminal apparatus 63 transmit uplink multicarrier signals at the same power level, normally, as shown in the upper half of FIG. 2, the average reception SIR of the uplink multicarrier signal from radio communication terminal apparatus 62 is lower than the average reception SIR of the uplink multicarrier signal from radio communication terminal apparatus 63.

Here, as shown in the lower half of FIG. 2, when frequency scheduling is performed using RR method, the subcarriers in the uplink multicarrier signal are assigned to radio communication terminal apparatuses 62 and 63 evenly. For example, four subcarriers of subcarrier numbers (hereinafter referred to as “SCN”) 3, 4, 7 and 8 are thus assigned to radio communication terminal apparatus 62 by the QPSK modulation scheme. Then, in this case, as shown in the upper half of FIG. 2, SCN8 alone has reception SIR of the uplink multicarrier signal from radio communication terminal apparatus 62 greater than the QPSK threshold, QPSK modulation data transmitted from radio communication terminal apparatus 62 by other subcarriers of SCN's 3, 4 and 7 cannot be demodulated at base station apparatus 61. Therefore, in this case, with respect to the QPSK modulation data transmitted by subcarriers of SCN's 3, 4, and 7 base station apparatus 61 was unable to demodulate, a retransmission request signal is transmitted from base station apparatus 61 to radio communication terminal apparatus 62. Consequently, in this case, the downlink transmission rate is reduced by transmission of this retransmission request signal, and the uplink transmission rate is also reduced by transmission of the retransmission data.

Further, as shown in the lower half of FIG. 2, in a case where scheduling is performed using the Max-C/I method, since a subcarrier to be assigned to radio communication terminal apparatus 62 is limited to SCN5, uplink transmission rate of radio communication terminal apparatus 62 is extremely low. In this case, if transmission power level from radio communication terminal apparatus 62 to base station apparatus 61 is increased, it is considered that the number of subcarriers in the uplink multicarrier signal assigned to radio communication terminal apparatus 62 can be increased. However, when transmission power level of radio communication terminal apparatus 62, is increased, an uplink multicarrier signal transmitted to radio communication terminal apparatus 62 to base station apparatus 61 becomes an interference signal to an uplink multicarrier signal transmitted from radio communication terminal apparatus 66 to base station apparatus 65, and, as a result, a new problem arises that uplink transmission rate in cell B is reduced.

Also, as shown in the lower half of FIG. 2, when scheduling is performed using the PF method, assignment of subcarriers in an uplink multicarrier signal is performed regardless of the absolute value of the average reception SIR of the uplink multicarrier signal calculated by base station apparatus 61, and a relatively large number of subcarriers in the uplink multicarrier signal (SCN's 1 and 4 to 6) are assigned to radio communication terminal apparatus 62. Thus, if scheduling is performed using the PF method, predetermined uplink transmission rate is more likely to be achieved with respect to radio communication terminal 62. However, if the number of subcarriers in the uplink multicarrier signal assigned to radio communication terminal apparatus 62 increases, transmission power level of radio communication terminal apparatus 62 increases in proportion to that number, and there is a problem that uplink transmission rate in cell B is reduced as described above.

It is therefore an object of the present invention to provide a scheduling method capable of maintaining uplink transmission rate within a cell, and minimizing adverse influences against other cells due to interference, that is, reduction in uplink transmission rate in the other cells, and a base station apparatus that implements the method.

### MEANS FOR SOLVING THE PROBLEM

A scheduling method according to the present invention for scheduling subcarriers in an uplink multicarrier signal which a base station apparatus allows a plurality of radio communication terminal apparatuses to use, the method having: a measurement step of measuring, per subcarrier, reception quality of an uplink multicarrier signal or a downlink multicarrier signal each radio communication terminal apparatus transmits or receives; a calculation step of calculating average reception quality of each radio communication terminal apparatus; a selection step of selecting the radio communication terminal apparatuses in ascending order of calculated average reception quality; and an assignment step of assigning a subcarrier in the uplink multicarrier signal to the selected radio communication terminal apparatus in descending order of reception quality measured in the measurement step.

A base station apparatus according to the present invention for performing radio communication with a plurality of radio communication terminal apparatuses, the base station apparatus having: a reception section that receives an uplink multicarrier signal transmitted by each of the plurality of radio communication terminal apparatuses; a measuring section that measures reception quality of the received uplink multicarrier signal per subcarrier; a scheduler that calculates average reception quality of the uplink multicarrier signal transmitted by each radio communication terminal apparatus, selects the radio communication terminal apparatuses in ascending order of average reception quality, and assigns a subcarrier in the uplink multicarrier signal to the selected radio communication terminal apparatus in descending order of reception quality measured in the measuring section; and a transmission section that transmits a downlink multicarrier signal formed with the subcarriers assigned by the scheduler.

A base station apparatus according to the present invention for performing radio communication with a plurality of radio communication terminal apparatuses, the base station apparatus having: a reception section that receives an uplink multicarrier signal containing control information whose content includes reception quality of a downlink multicarrier signal per subcarrier measured by each of the plurality of radio communication terminal apparatuses; a scheduler that calculates average reception quality of the downlink multicarrier signal transmitted by each radio communication terminal apparatus, selects the radio communication terminal apparatuses in ascending order of average reception quality, and assigns a subcarrier in the uplink multicarrier signal to the selected radio communication terminal apparatus in descending order of reception quality measured in the measuring section; and a transmission section that transmits a downlink multicarrier signal formed with the subcarriers assigned by the scheduler.

### ADVANTAGEOUS EFFECT OF THE INVENTION

According to the present invention, a base station apparatus selects radio communication terminal apparatuses in ascending order of average reception quality, and assigns subcarriers having high reception quality at the selected radio communication terminal apparatus to a selected radio communication terminal apparatus in descending order of reception quality among the subcarriers in the uplink multicarrier signal that are yet to be assigned, so that it is possible to assign subcarriers in the uplink multicarrier signal preferentially to the radio communication terminal apparatus having low average reception level. As a result, according to the present invention, it is possible to maintain high uplink transmission rate in a cell and minimize interference against other cells.

Also, according to the present invention, upon assignment of subcarriers in an uplink multicarrier signal to a plurality of radio communication terminal apparatuses, for each radio communication terminal apparatus, reception quality of one of an uplink multicarrier signal and a downlink multicarrier signal is measured per subcarrier, and, based on the measurement result, an applicable modulation scheme having the highest transmission rate is adopted to each assigned subcarrier in the uplink multicarrier signal, so that it is possible to effectively reduce the number of subcarriers assigned to the radio communication terminal apparatus having low average reception quality in the uplink multicarrier signal. As a result, it is possible to further reduce transmission power level of the uplink multicarrier signal transmitted from the radio communication terminal apparatus having low average reception quality and minimize interference against other cells.

### BRIEF DESCRIPTION OF DRAWINGS

FIG. 1 is a view showing a configuration example of a radio communication system formed with two cells whose communication areas are adjacent to each other;

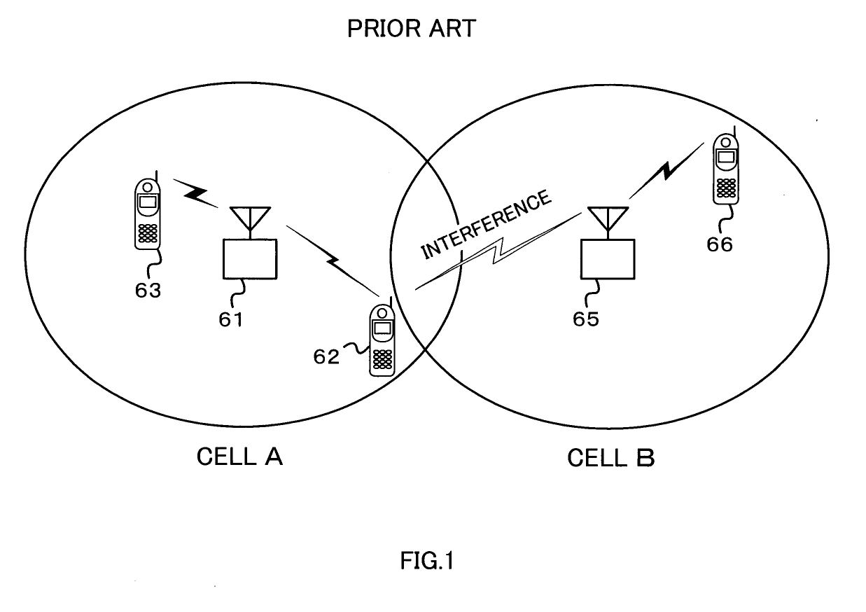

FIG. 2 is a graph showing an example where a known time scheduling method is applied to frequency scheduling on subcarriers in a multicarrier signal;

FIG. 3 is a block diagram showing a configuration of a base station apparatus according to Embodiment 1 of the present invention;

FIG. 4 is a block diagram showing a configuration of a radio communication terminal apparatus according to Embodiment 1 of the present invention;

FIG. 5 is a view showing an example of assigning subcarriers according to a scheduling method of Embodiment 1;

FIG. 6 is a block diagram showing a configuration of a base station apparatus according to Embodiment 2 of the present invention; and

FIG. 7 is a block diagram showing a configuration of a radio communication terminal apparatus according to Embodiment 2 of the present invention.

### BEST MODE FOR CARRYING OUT THE INVENTION

Now, embodiments of the present invention will be described below in detail with reference to the accompanying drawings.

### Embodiment 1

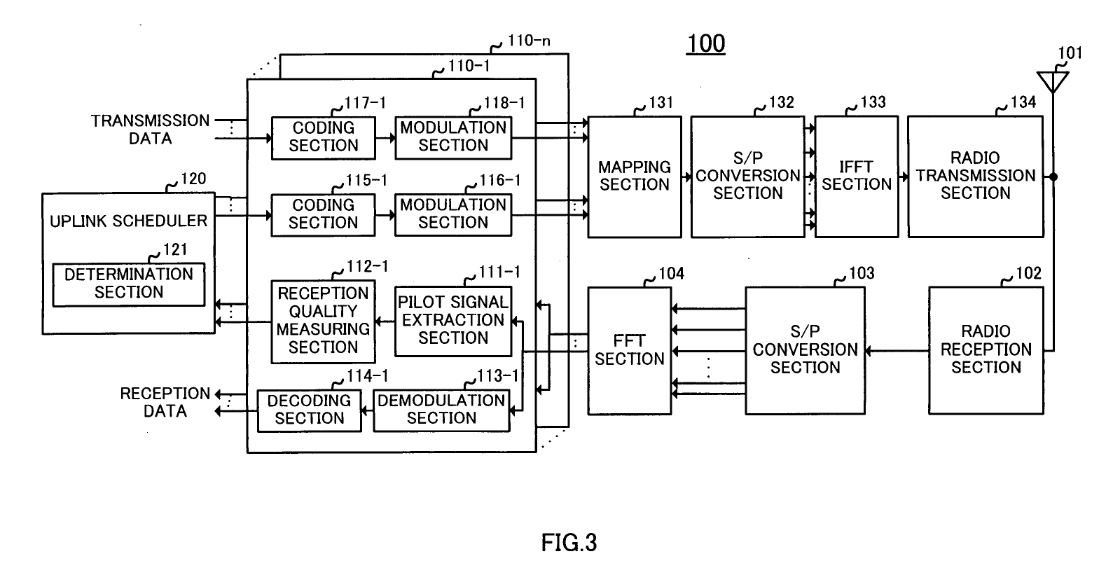

FIG. 3 is a block diagram showing a configuration of base station apparatus 100 according to Embodiment 1 of the present invention. Base station apparatus 100 provides: antenna element 101; radio reception section 102; S/P conversion section 103; FFT section 104; terminal response section 110; uplink scheduler 120; mapping section 131; S/P conversion section 132; IFFT section 133; and radio transmission section 134. In this embodiment, base station apparatus 100 communicates simultaneously with the plurality of radio communication terminal apparatuses 200 (described later) by performing frequency scheduling of an OFDM (Orthogonal Frequency Division Multiplexing) signal.

Terminal response sections 110 are provided so as to be equal in number to the maximum number of radio communication terminal apparatuses 200 that are able to simultaneously communicate with base station apparatus 100, and corresponding (communicating) radio communication terminal apparatuses 200 are determined upon each use. Radio communication terminal apparatus 200 will be described later. Further, terminal response sections 110 each provide: pilot signal extraction section 111; reception quality measuring section 112; demodulation section 113; decoding section 114; coding sections 115 and 117; and modulation sections 116 and 118. In FIG. 3, although terminal response sections 110 are shown with branch numbers 1 to n so as to be distinguished from each other, terminal response sections 100-1 to 100-n perform the same functions and the branch numbers may be omitted when those functions and the like are described. Also, uplink scheduler 120 provides determination section 121.

Antenna element 101 acquires uplink multicarrier signals transmitted from the plurality of radio communication terminal apparatuses 200, inputs the signals to radio reception section 102, and transmits downlink multicarrier signals from radio transmission section 134 to the plurality of radio communication terminal apparatuses 200 by radio.

Radio reception section 102 is configured to include, for example, a bandpass filter, an A/D converter, and a low noise amplifier, performs predetermined received signal processing such as noise removal, amplification, and guard interval removal on the uplink multicarrier signal inputted from antenna element 101, and then inputs the uplink multicarrier signal subjected to the received signal processing to S/P conversion section 103.

S/P conversion section 103 converts the uplink multicarrier signal inputted from radio reception section 103 to a plurality of parallel signals and inputs the parallel signals after the conversion to FFT section 104.

FFT section 104 performs, for example, Fourier transform processing on the plurality of parallel signals inputted from S/P conversion section 103, converts the signals into a serial signal, and inputs the uplink multicarrier signal converted into the serial signal to pilot signal extraction sections 111-1 to 111-n and demodulation sections 113-1 to 113-n, respectively, in terminal response sections 110-1 to 110-n.

Pilot signal extraction section 111 extracts only the segment related to corresponding radio communication terminal apparatus 200 among the uplink multicarrier signals inputted from FFT section 104, further extracts a pilot signal among the uplink multicarrier signals in the extracted segment, and inputs the extracted pilot signal to reception quality measuring section 112.

Reception quality measuring section 112 measures reception SIR per subcarrier for all the subcarriers forming the uplink multicarrier signal transmitted from the corresponding radio communication terminal apparatus 200 using the pilot signal inputted from pilot signal extraction section 111, and inputs the measurement result to uplink scheduler 102.

Demodulation section 113 extracts only the segment related to the corresponding radio communication terminal apparatus 200 from the uplink multicarrier signals inputted from FFT section 104 and demodulates the uplink multicarrier signal of the extracted segment by a predetermined scheme. Also, demodulation section 113 inputs the demodulated uplink multicarrier signal to decoding section 114.

Decoding section 114 performs decoding processing on the uplink multicarrier signal inputted from demodulation section 113 by a preset scheme, generates reception data, and inputs the generated reception data to a baseband section (not shown).

Based on the measurement results of reception SIR of the pilot signals per subcarrier contained in the uplink multicarrier signals of radio communication terminal apparatuses 200 inputted from reception quality measuring sections 112-1 to 112-n, uplink scheduler 120 calculates average reception SIR of the uplink multicarrier signals of radio communication terminal apparatuses 200 and selects radio communication terminal apparatuses 200 in ascending order of calculated average reception SIR. Also, uplink scheduler 120 assigns the subcarrier that are yet to be assigned in the uplink multicarrier signal to the selected radio communication terminal apparatus 200 in descending order of reception SIR shown in the measurement result of the selected radio communication terminal apparatus 200 inputted from reception quality measuring section 112.

Here, upon assignment of subcarriers in the uplink multicarrier signal to the selected radio communication terminal apparatus 200, for each subcarrier of the uplink multicarrier signal, determination section 121 of uplink scheduler 120 determines an applicable modulation scheme having the highest transmission rate based on reception SIR shown in the measurement result for the selected radio communication terminal apparatus 200 inputted from reception quality measuring section 112. Then, uplink scheduler 120 assigns the subcarriers in the uplink multicarrier signal to the selected radio communication terminal apparatus according to the transmission rate corresponding to the determined modulation scheme until the transmission rate scheduled for radio communication terminal apparatus 200 is satisfied. This step of assigning subcarriers in an uplink multicarrier signal by uplink scheduler 120 will be described in detail later.

Then, to allow each of the plurality of radio communication terminal apparatuses 200 to use the assigned subcarriers in the uplink multicarrier signals in subsequent transmissions of uplink multicarrier signals, uplink scheduler 120 generates signals for reporting the assigned subcarriers in the uplink multicarrier signals and the modulation schemes applied to the subcarriers (hereinafter referred to as “subcarrier report signal”), and inputs these subcarrier report signals to coding sections 115-1 to 115-n.

Coding section performs coding processing on the subcarrier report signal inputted from uplink scheduler 120 by a preset scheme, and then inputs the coded subcarrier report signal to modulation section 116.

Modulation section 116 performs modulation processing on the subcarrier report signal inputted from coding section 115 by a predetermined scheme, and then inputs the subcarrier report signal subjected to the modulation processing to mapping section 131.

Coding section 117 performs coding processing on the transmission data for a downlink multicarrier signal inputted from, for example, a baseband section (not shown) by a preset scheme, and inputs the coded transmission data to modulation section 118.

Modulation section 118 performs modulation processing on the coded transmission data inputted from coding section 117 by a predetermined scheme, and then inputs the transmission data subjected to the modulation processing to mapping section 131.

IFFT section 133 performs inverse Fourier transform processing (described later) and so on on the subcarrier report signals inputted from modulation sections 116-1 to 116-n and transmission data for a downlink multicarrier signal inputted from modulation sections 118-1 to 118-n. Mapping section 131 then performs mapping so as to assign those signals to the subcarriers in the downlink multicarrier signal, each subcarrier having good reception quality in the uplink multicarrier signal for radio communication terminal apparatuses 200. Then, mapping section 131 inputs the signal subjected to mapping to S/P conversion section 132.

S/P conversion section 132 converts the signal subjected to mapping and inputted from mapping section 131 to parallel signals and inputs all the converted parallel signals to IFFT section 133.

IFFT section performs inverse Fourier transform processing and so on on the parallel signal inputted from S/P conversion section 132, generates a downlink multicarrier signal by converting the parallel signal to a serial signal, and inputs the generated downlink multicarrier signal to radio transmission section 134.

Radio transmission section 134 is configured to include, for example, a bandpass filter, a D/A converter, and a low noise amplifier, inserts a guard interval into the downlink multicarrier signal inputted from IFFT section 133, performs predetermined transmission signal processing such as amplification and frequency selection, and transmits the downlink multicarrier signal subjected to predetermined transmission signal processing to the plurality of radio communication terminal apparatuses 200 via antenna element 101.

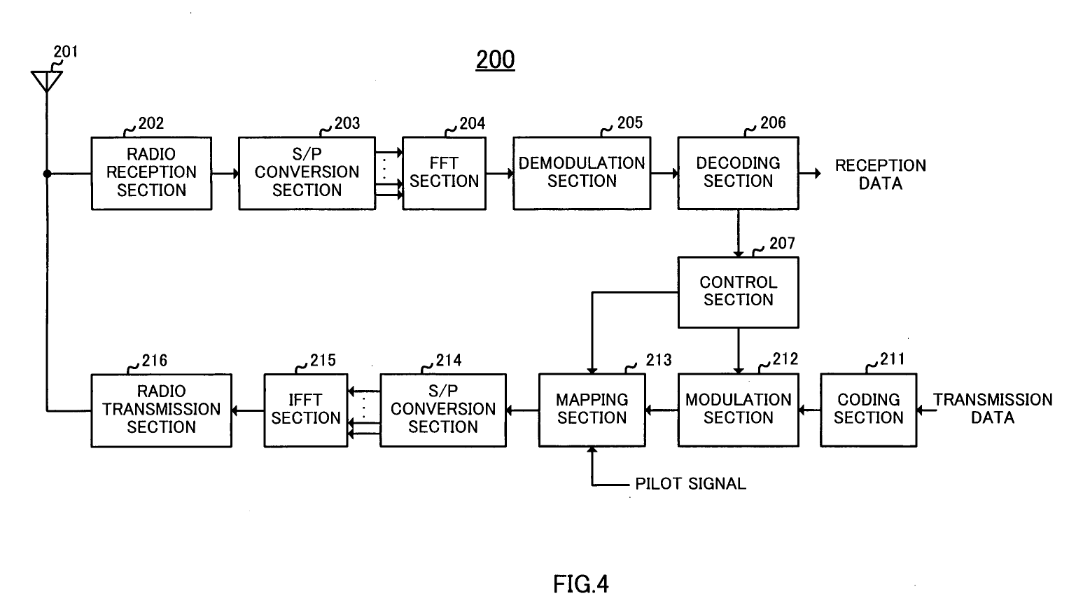

FIG. 4 is a block diagram showing a configuration of radio communication terminal apparatus 200 performing radio communication with base station apparatus 100 of an OFDMA (orthogonal Frequency Division Multiplexing Access) scheme. Radio communication terminal apparatus 200 provides: antenna element 201; radio reception section 202; S/P conversion section 203; FFT section 204; demodulation section 205; decoding section 206; control section 207; coding section 211; modulation section 212; mapping section 213; IFFT section 215; and radio transmission section 216.

Antenna element 201 acquires the downlink multicarrier signal transmitted from base station apparatus 100, inputs the signal to radio reception section 202, and transmits an uplink multicarrier signal from radio transmission section 216 to base station apparatus 100 by radio.

Radio reception section 202 is configured to include, for example, a bandpass filter, an A/D converter, and a low noise amplifier, performs predetermined received signal processing such as noise removal, amplification, and guard interval removal on the downlink multicarrier signal inputted from antenna element 201, and then inputs the downlink multicarrier signal subjected to received signal processing to S/P conversion section 103.

S/P conversion section 203 converts the downlink multicarrier signal inputted from radio reception section 202 to a plurality of parallel signals and inputs the parallel signals after conversion to FFT section 204.

FFT section 204 performs Fourier transform processing and so on on the plurality of parallel signals inputted from S/P conversion section 203, converts the signals into a serial signal, and inputs the downlink multicarrier signal converted into the serial signal to demodulation section 205.

Demodulation section 205 demodulates the downlink multicarrier signal inputted from FFT section 204 by a predetermined scheme, and then inputs the downlink multicarrier signal after demodulation to decoding section 206.

Decoding section 206 decodes the downlink multicarrier signal after demodulation inputted from demodulation section 205 by a preset scheme and generates reception data and a subcarrier report signal. Then, decoding section 206 inputs the generated reception data to a baseband section (not shown), and inputs the generated subcarrier report signal to control section 207.

Control section 207 controls modulation section 212 and mapping section 213 according to a designation by the subcarrier report signal inputted from decoding section 206 so that transmission data transmitted from radio communication terminal apparatus 200 to base station apparatus 100 is modulated by a designated modulation scheme and is transmitted by a designated subcarrier.

Coding section 211 performs coding processing on transmission data for base station apparatus 100 inputted from, for example, a baseband (not shown) section by a preset scheme, and inputs the coded transmission data to modulation section 212.

Modulation section 212 performs modulation processing on the coded transmission data inputted from coding section 211 by the modulation scheme designated by control section 207, and inputs the transmission data subjected to modulation processing to mapping section 213.

After IFFT section 215 performs the inverse Fourier transform processing (described later) and so on on the transmission data inputted from modulation section 212, mapping section 213 performs mapping processing so that the transmission data is arranged in the subcarrier designated by control section 207. Further, mapping section 213 receives a pilot signal inputted from a pilot signal generation section (not shown), and maps so that this pilot signal is arranged evenly to all the subcarriers forming the uplink multicarrier signal. Mapping section 213 maps the transmission data inputted from modulation section 212 and the pilot signal, separately, in time division. Then, mapping section 213 inputs the signal subjected to mapping processing to S/P conversion section 214.

S/P conversion section 214 converts the signal subjected to mapping processing and inputted from mapping section 213 to a parallel signal and inputs the parallel signal to IFFT section 215.

IFFT section 215 performs inverse Fourier transform and so on on the parallel signal inputs from S/P conversion section 214 and converts the parallel signal to a serial signal, thereby generating an uplink multicarrier signal. Further, IFFT section 215 inputs the generated uplink multicarrier signal to radio transmission section 216.

Radio transmission section 216 is configured to include, for example, a bandpass filter, a D/A converter, and a low noise amplifier, inserts a guard interval into the uplink multicarrier signal inputted from IFFT section 215, performs predetermined transmission signal processing such as amplification and frequency selection, and then transmits the uplink multicarrier signal to base station 100 via antenna element 201.

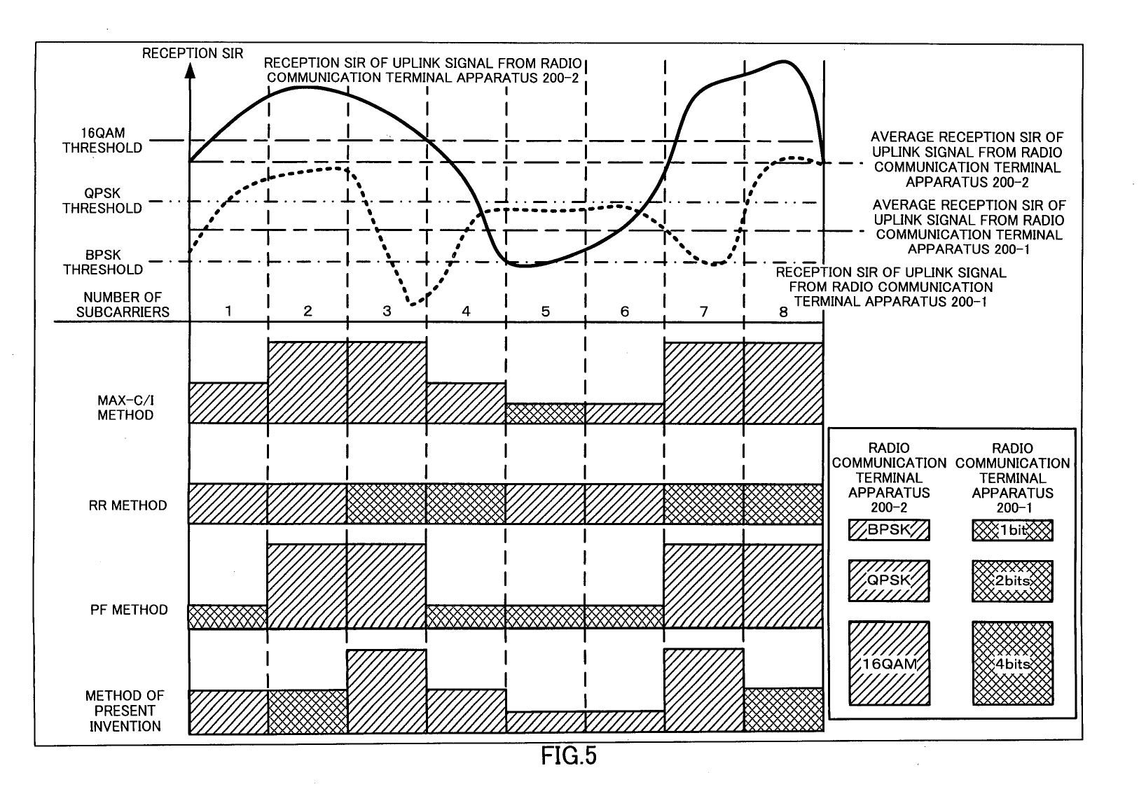

Next, the operations of base station apparatus 100 will be described in detail, focusing on uplink scheduler 120, with reference to FIG. 5.

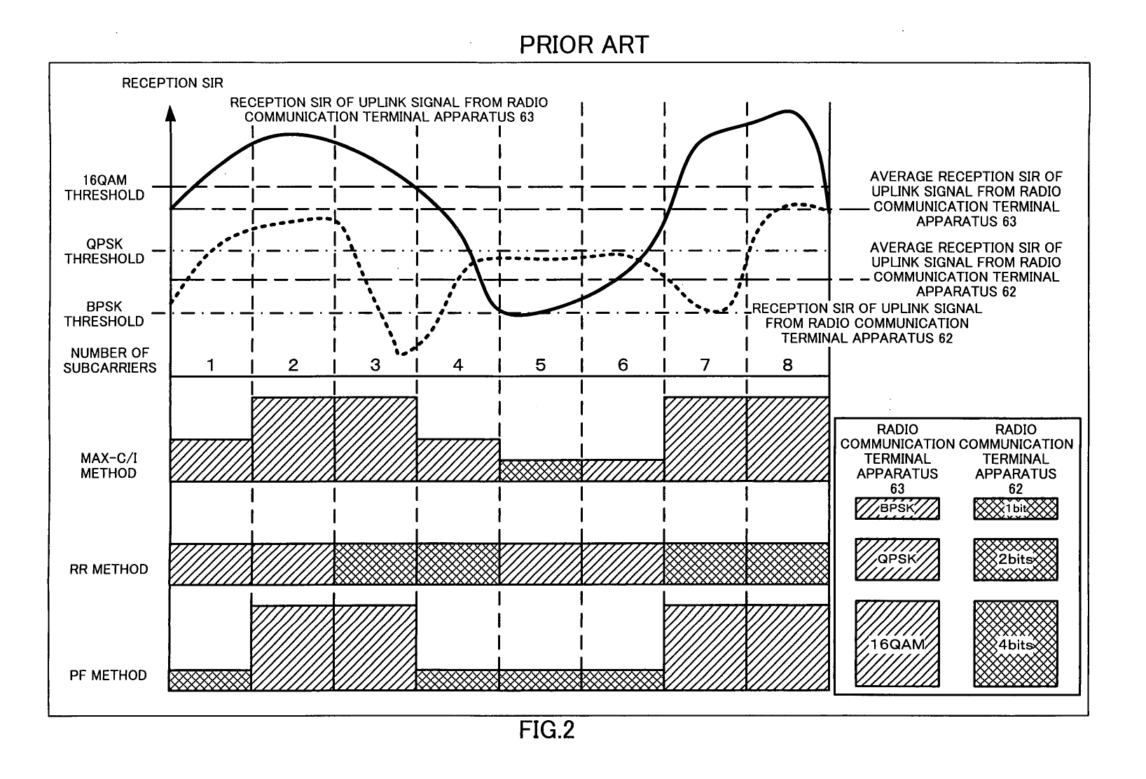

FIG. 5 is a view in which an example where subcarriers in an uplink multicarrier signal are assigned to two radio communication terminal apparatuses 200-1 and 200-2 is added to the lower half of FIG. 2. Here, assume that radio communication terminal apparatus 200-1 is located on a cell edge and radio communication terminal apparatus 200-2 is located relatively near base station apparatus 100. Therefore, in FIG. 5, average reception SIR of the uplink multicarrier signal from radio communication terminal apparatus 200-1 is lower than average reception SIR of the uplink multicarrier signal from radio communication terminal apparatus 200-2.

In the scheduling method according to this embodiment, reception quality measuring sections 112-1 and 112-2 measure reception SIR of the uplink multicarrier signals per subcarrier transmitted by radio communication terminal apparatuses 200-1 and 200-2.

Then, based on the measurement result, uplink scheduler 120 calculates average reception SIR of the uplink multicarrier signals from radio communication terminal apparatuses 200-1 and 200-2.

Next, uplink scheduler 120 selects, in ascending order of average reception SIR, the radio transmission communication terminal apparatuses 200-1 first, and assigns SCN8 having the highest reception SIR to radio communication terminal apparatus 200-1. At this time, uplink scheduler 120 confirms which threshold of BPSK, QPSK, or 16QAM the reception SIR of SCN8 in the uplink multicarrier signal of radio communication terminal apparatus 200-1 exceeds. Then, determination section 121 in uplink scheduler 120 determines that the modulation scheme having the highest transmission rate and applicable to radio communication terminal apparatus 200-1 with respect to SCN8, is QPSK. Here, assume that transmission rate of BPSK is one bit, transmission rate of QPSK is two bits, and transmission rate of 16QAM is four bits, and, transmission rate scheduled for radio communication terminal apparatus 200-1 in an uplink multicarrier signal is four bits. This means, by assigning SCN8 to radio communication terminal apparatus 200-1, radio communication terminal apparatus 200-1 secures transmission rate of two bits for the uplink multicarrier signal and only needs to secure the remaining two bits.

Next, uplink scheduler 120 assigns SCN2 having the highest reception SIR next to SCN8 to radio communication terminal apparatus 200-1 among SCN's 1 to 7 that are yet to be assigned in the uplink multicarrier signal. Here, a modulation scheme having the highest transmission rate and applicable to radio communication terminal apparatus 200-1 with respect to SCN2 is QPSK, so that, by assigning SCN2 in the uplink multicarrier signal to radio communication terminal apparatus 200-1, transmission rate of four bits scheduled for radio communication terminal apparatus 200-1 in the uplink multicarrier signal is satisfied.

Uplink scheduler 120 then selects radio communication apparatus 200-2, and sequentially assigns the subcarriers in the uplink multicarrier signal using the same technique as for the case of radio communication terminal apparatus 200-2.

In this way, according to the scheduling method of the present invention, base station apparatus 100 selects radio communication terminal apparatus 200 in ascending order of average reception SIR of the uplink multicarrier signal, and assigns a subcarrier having high reception SIR at the uplink multicarrier signal from the selected radio communication terminal apparatus 200 among the subcarriers that are yet to be assigned in the uplink multicarrier signal to the selected radio communication terminal apparatus in descending order of reception SIR, so that it is possible to assign the subcarriers preferentially to radio communication terminal apparatus having the uplink multicarrier signal having low reception SIR. As a result, according to the scheduling method of the present invention, it is possible to maintain high uplink transmission rate in a cell where radio communication terminal apparatus 200 is located, and minimize interference against other cells.

Also, according to the scheduling method of this embodiment, upon assignment of subcarriers in an uplink multicarrier signal to a plurality of radio communication terminal apparatuses 200, for each radio communication terminal apparatus 200, reception SIR of the uplink multicarrier signal is measured per subcarrier, and, based on the measurement result, an applicable modulation scheme having the highest transmission rate is adopted to each assigned subcarrier in the uplink multicarrier signal, so that it is possible to effectively reduce the number of subcarriers assigned to radio communication terminal apparatus 200 having an uplink multicarrier signal of low average reception SIR. As the result, it is possible to further minimize transmission power level of an uplink multicarrier signal transmitted from radio communication terminal apparatus 200 having an uplink multicarrier signal of low average reception SIR, and further reduces interference against other cells.

Still further, according to the scheduling method of the present invention, when transmission power level of the uplink multicarrier signal of radio communication terminal apparatus 200 decreases, all the signal processing such as measurement of reception SIR of an uplink multicarrier signal from radio communication terminal apparatus 200 are performed in base station apparatus 100, so that it is possible to reduce power consumption in radio communication terminal apparatus 200.

Base station apparatus 100 and radio communication terminal apparatus 200 according to this embodiment may be applied or modified as below.

Although a case has been described in this embodiment where reception quality measuring section 112 measures reception SIR of the pilot signal contained in the uplink multicarrier signal, this invention is not limited to this case, and, for example, reception quality measuring section 112 may measure reception power level of the pilot signal contained in the uplink multicarrier signal. By this means, it is not necessary to measure power level of an interference signal of the pilot signal contained in the uplink multicarrier signal in reception quality measuring section 112, so that load of signal processing in reception quality measuring section 112 can be reduced.

Furthermore, although a case has been described as a specific example in this embodiment where the number of radio communication terminal apparatuses which communicate with base station 100 simultaneously is two and the number of subcarriers in an uplink multicarrier signal is eight, this invention is by no means limited to this specific example.

### Embodiment 2

Embodiment 2 of the present invention has a feature that a plurality of radio communication terminal apparatuses 500 measure reception SIR of pilot signals contained in downlink multicarrier signals, and transmit the measurement results to base station apparatus 400 as control information by uplink multicarrier signals.

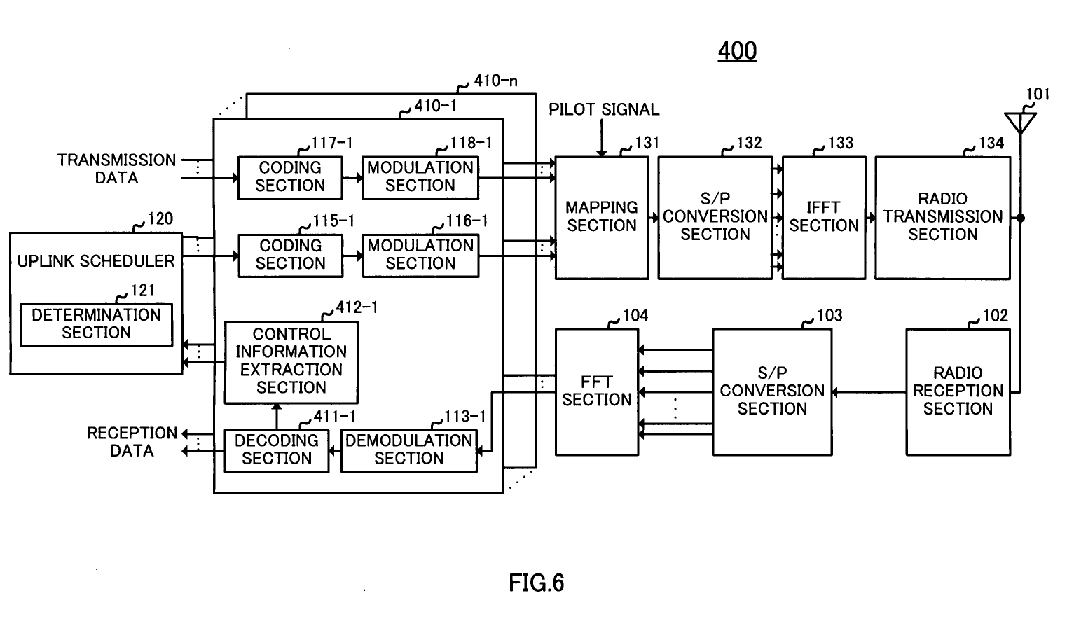

FIG. 6 is a block diagram showing a configuration of base station 400 according to this embodiment. Base station 400 provides terminal response section 410 in place of terminal response section 110 of base station apparatus 100, and, further, terminal response apparatus 410 provides decoding section 411 and control information extraction section 412 in place of pilot signal extraction section 111, reception quality measuring section 112 and decoding section 114 of terminal response section 110. As base station apparatus 400 thus provides many components that perform the same functions as the components of base station apparatus 100, such components that perform the same functions are therefore assigned the same reference codes as in the components of base station apparatus 100, and their descriptions will be omitted.

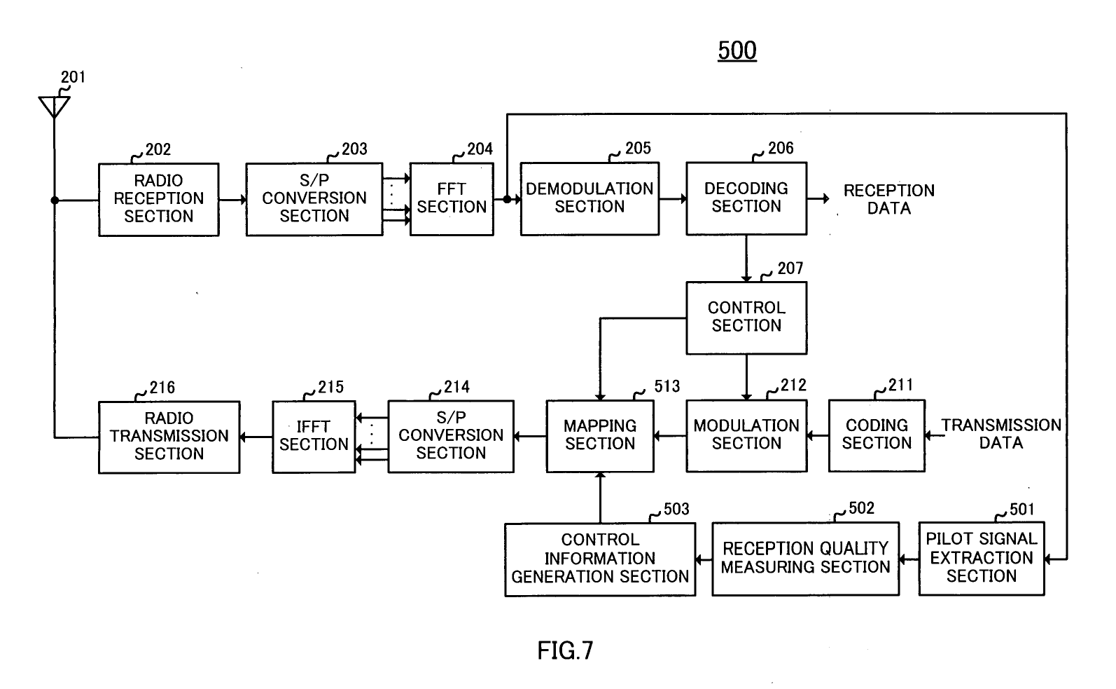

Also, FIG. 7 is a block diagram showing a configuration of radio communication terminal apparatus 500 according to this embodiment. Radio communication terminal apparatus 500 adds pilot signal extraction section 501, reception quality measuring section 502, and control information generation section 503 to radio communication terminal apparatus 200, and provides mapping section 513 having some other functions in place of mapping section 213. As radio communication terminal apparatus 500 thus provides many components that perform the same functions as the components of radio communication terminal apparatus 200, such components that perform the same functions are therefore assigned the same reference codes as in the components of radio communication terminal apparatus 200, and their descriptions will be omitted.

Decoding section 411 performs decoding processing on the uplink multicarrier signal inputted from demodulation section 113 by a preset scheme, generates reception data, and inputs the generates reception data to control information extraction section 412 and a baseband section (not shown), respectively.

Control information extraction section 412 extracts control information generated by radio communication terminal apparatus 500 and contained in the reception data inputted from decoding section 411, and inputs the extracted control information to uplink scheduler 120. In this extracted control information, information on reception SIR of a downlink multicarrier signal measured per subcarrier received by radio communication terminal apparatus 500 is contained, and uplink scheduler 120 executes the scheduling method according to the above described Embodiment 1 based on this information on reception SIR of the down link multicarrier per subcarrier generated by radio communication terminal apparatus 500.

Mapping section 131 inserts a pilot signal into the downlink multicarrier signal so that radio communication terminal apparatus 500 receiving the downlink multicarrier signal can measure reception SIR per subcarrier.

Then, pilot signal extraction section 501 in radio communication terminal apparatus 500 extracts the pilot signal from the downlink multicarrier signal inputted from FFT section 204 and inputs the extracted pilot signal to reception quality measuring section 502.

Reception quality measuring section 502 measures reception SIR per subcarriers for all the subcarriers forming the downlink multicarrier signal using the pilot signal inputted from pilot signal extraction section 501, and inputs the measurement result to control information generation section 503.

Control information generation section 503 converts the measurement result of the reception SIR of the downlink multicarrier signal per subcarrier inputted from reception quality measuring section 502 to a predetermined format, generates control information, and inputs the generated control information to mapping section 513 after performing a predetermined transmission signal processing such as coding processing and modulation processing on the generated control information.

After IFFT section 215 performs inverse Fourier transform processing and so on on transmission data inputted from modulation section 212 and the control information inputted from control information generation section 503, mapping section 513 performs mapping processing so that the transmission data and the control information are arranged in a subcarrier designated by control section 207. Mapping section 513 then inputs the signal subjected to mapping processing to conversion section 214.

In this way, according to this embodiment, each of the plurality of radio communication terminal apparatuses 500 measures reception SIR of pilot signals contained in downlink multicarrier signals and transmits the measurement result to base station apparatus 400 by the uplink multicarrier signal, so that it is possible to reduce load of signal processing in base station apparatus 400.

Although reception quality of a multicarrier signal has been measured per subcarrier and a subcarrier has been assigned based on the measurement result in the above embodiment, this is not limited to a subcarrier, and other resources, for example, spatial resources such as transmission antenna, directivity pattern, diffusion code in a CDMA system, and time slot in a TDMA system may also be used.

In addition, each of functional blocks employed in the description of each of above mentioned Embodiments may typically be implemented as an LSI constituted by an integrated circuit. These are may be individual chips or partially or totally contained on a single chip.

“LSI” is adopted here but this may also be referred to as an “IC”, “system LSI”, “super LSI”, or “ultra LSI” depending on differing extents of integration.

Further, the method of integrating circuits is not limited to the LSI's, and implementation using dedicated circuitry or general purpose processor is also possible. After LSI manufacture, utilization of FPGA (Field Programmable Gate Array) or a reconfigurable processor where connections or settings of circuit cells within an LSI can be reconfigured is also possible.

Furthermore, if integrated circuit technology comes out to replace LSI's as a result of the advancement of semiconductor technology or derivative other technology, it is naturally also possible to carry out function block integration using this technology. Application in biotechnology is also possible.

This application is based on Japanese Patent Application No. 2004-70254, filed on Mar. 12, 2004, the entire content of which is expressly incorporated by reference herein.

### INDUSTRIAL APPLICABILITY

The scheduling method and base station apparatus according to the present invention provide advantages of maintaining high uplink transmission rate in a cell and minimizing interference against other cells, and are useful in radio communication system of, for example, a multicarrier transmission scheme.

1. A scheduling method for scheduling subcarriers in an uplink multicarrier signal which a base station apparatus allows a plurality of radio communication terminal apparatuses to use, the method comprising:
a measurement step of measuring, per subcarrier, reception quality of an uplink multicarrier signal or a downlink multicarrier signal each radio communication terminal apparatus transmits or receives;
a calculation step of calculating average reception quality of each radio communication terminal apparatus;
a selection step of selecting the radio communication terminal apparatuses in ascending order of calculated average reception quality; and
an assignment step of assigning a subcarrier in the uplink multicarrier signal to the selected radio communication terminal apparatus in descending order of reception quality measured in the measurement step.

2. The scheduling method according to claim 1, further comprising a determination step of determining a modulation scheme having the highest transmission rate and applicable to the subcarriers in the uplink multicarrier signal for each radio communication terminal apparatus based on the measurement result of reception quality in the measurement step,
wherein, in the assignment step, the subcarrier in the uplink multicarrier signal is assigned, in descending order of reception quality measured in the measurement step, to the radio communication terminal apparatuses selected in the selection step in accordance with transmission rate corresponding to the modulation scheme determined in the determination step until predetermined transmission rate scheduled for the radio transmission terminal apparatus is satisfied.

3. A base station apparatus for performing radio communication with a plurality of radio communication terminal apparatuses, the base station apparatus comprising:
a reception section that receives an uplink multicarrier signal transmitted by each of the plurality of radio communication terminal apparatuses;
a measuring section that measures reception quality of the received uplink multicarrier signal per subcarrier;
a scheduler that calculates average reception quality of the uplink multicarrier signal transmitted by each radio communication terminal apparatus, selects the radio communication terminal apparatuses in ascending order of average reception quality, and assigns a subcarrier in the uplink multicarrier signal to the selected radio communication terminal apparatus in descending order of reception quality measured in the measuring section; and
a transmission section that transmits a downlink multicarrier signal formed with the subcarriers assigned by the scheduler.

4. The base station apparatus according to claim 3, wherein the scheduler comprises a determination section that determines a modulation scheme having the highest transmission rate and applicable to the subcarriers in the uplink multicarrier signal for each radio communication terminal apparatus based on the measurement result of reception quality of the uplink multicarrier signal per subcarrier by the measuring section, calculates average reception quality of the uplink multicarrier signal each radio communication terminal apparatus transmits, selects the radio communication terminal apparatus in ascending order of calculated reception quality, and assigns the subcarrier in the uplink multicarrier signal to the selected radio communication terminal apparatus in descending order of reception quality measured in the measuring section.

5. A base station apparatus for performing radio communication with a plurality of radio communication terminal apparatuses, the base station apparatus comprising:
a reception section that receives an uplink multicarrier signal containing control information whose content includes reception quality of a downlink multicarrier signal per subcarrier measured by each of the plurality of radio communication terminal apparatuses;
a scheduler that calculates average reception quality of the downlink multicarrier signal transmitted by each radio communication terminal apparatus, selects the radio communication terminal apparatuses in ascending order of average reception quality, and assigns a subcarrier in the uplink multicarrier signal to the selected radio communication terminal apparatus in descending order of reception quality measured in the measuring section; and
a transmission section that transmits a downlink multicarrier signal formed with the subcarriers assigned by the scheduler.

6. The base station apparatus according to claim 5, wherein:
the scheduler comprises a determination section that determines a modulation scheme having the highest transmission rate and applicable to the subcarriers in the uplink multicarrier signal for each radio communication terminal apparatus based on the control information; and
the scheduler calculates average reception quality of the downlink multicarrier signal each radio communication terminal apparatus receives, selects the radio communication terminal apparatus in ascending order of calculated reception quality, and assigns the subcarrier in the uplink multicarrier signal to the selected radio communication terminal apparatus in descending order of reception quality measured in the measuring section in accordance with transmission rate corresponding to the modulation scheme determined in the determination section until predetermined transmission rate scheduled for the radio transmission terminal apparatus is satisfied.
